(19) United States
(12) Patent Application Publication
(10) Pub. No.: US 2008/0173580 A1
(43) Pub. Date: Jul. 24, 2008

(54) Liquid Filter System

(75) Inventor: Teng Hee Leow, Singapore (SG)

Correspondence Address: SUGHRUE MION, PLLC, 2100 PENNSYLVANIA AVENUE, N.W., SUITE 800, WASHINGTON, DC, 20037, US

(73) Assignee: ESCO PROCESS (ASIA PACIFIC) PTE LTD, Singapore (SG)

(21) Appl. No.: 11/908,044

(22) PCT Filed: May 31, 2005
(86) PCT No.: PCT/SG2005/000170

§ 371 Date: Nov. 9, 2007

(30) Foreign Application Priority Data
Mar. 7, 2005 (AU) 2005901070

(51) Int. Cl. B01D 29/05

(52) U.S. Cl. 210/498

(57) ABSTRACT

A filter system is described which comprises a vessel (10) containing a plurality of sets of discs (41). Each set of discs (41) comprises a number of discs (40) stacked one above the other. The discs (40) have grooves (50) on their opposite sides so that media to be filtered passes through the grooves and contaminants in the media are prevented from passing through the grooves or trapped by the grooves. A backwash system (25) is provided for supplying air to force liquid in the opposite direction through the grooves to wash any contaminant out of the grooves. An air vent (26) is provided for allowing compressed air to escape from the vessel (10) and an outlet (16) is provided for discharge of contaminant.

### FIELD OF THE INVENTION

This invention relates to a liquid filter system for use in relation to various environments, including oil recovery, drinking water and sewerage in which fine filtration or microfiltration of the liquid is required. For example, in the oil field environment, water needs to be filtered to remove contaminants of particle sizes above 5 to 2 microns and possibly up to one micron.

### BACKGROUND OF THE INVENTION

Enhanced oil recovery applications in oil field production or pre-treatment for membrane systems require treatment of influent water quality to 1 to 5 microns. This treatment is normally considered as fine filtration or microfiltration. Available technology to achieve this has been multimedia filter technology using granular media or membrane technologies or cartridge filters. All of these techniques require frequent media replacement and maintenance. Cartridge filters are used more of a backup or insurance after the two former methods have been implemented. Membrane technologies at the microfiltration level require a high degree of maintenance and replacement and are also expensive. These systems also have a high continuous reject rate (typically in the order of 30% of the influent).

### SUMMARY OF THE INVENTION

The object of the invention is to provide a system which improves filtration whilst reducing costs and complexity.

The invention may be said to reside in a liquid filtration system comprising:
a plurality of discs, each having a surface, an inner periphery and an outer periphery, a hole in each disc defining the inner periphery;
a support for supporting the discs one above another;
a plurality of grooves in the surface of each disc extending from the inner periphery to the outer periphery;
a vessel for containing the discs;
an inlet in the vessel for liquid to be treated so the liquid flows through the grooves in one direction, preventing or trapping contamination in the liquid from passing through the grooves in one direction;
a backwash system for providing washing fluid for flow in the opposite direction to wash and drain off any retained contaminant out of the grooves;
a vent system to remove trap air after backwash and
a filtered water outlet from the vessel.

Depending on the size of the grooves which are employed, contaminants of very small sizes can be rejected and therefore, filtered from the liquid. Compared to microfiltration membrane type systems of an equivalent system, there is substantially no reject rate to consider. The invention provides significantly longer life cycle, reusable and smaller footprint than membrane-type equivalent systems or traditional multimedia sand filtration. The invention also requires no scouring, significantly less chemical, has no media loss through migration downstream, less backwash volume required and is reusable and recyclable as otherwise experienced with sand or multimedia filters.

Preferably the surface of each disc is defined by a first surface and an opposite second surface, and a plurality of grooves are formed in both the first surface and the opposite second surface.

Preferably the vessel is divided into a first chamber for receiving unfiltered liquid and a second chamber for receiving filtered liquid, the support means supporting the discs in the second chamber so that influent liquid must flow through the grooves of the disc for filtration before entering the first chamber.

Preferably the support comprises a baffle having a plurality of downwardly extending support webs which are received in the holes of the discs so that liquid must flow through the grooves and then into the support webs and then into the first chamber, so that any contaminate is filtered by the discs during the passage of the fluid from the second chamber through the grooves to the first chamber.

Preferably the first chamber has the liquid outlet for filtered liquid.

Preferably the inlet for unfiltered liquid is located for communication with the second chamber.

Preferably the support webs comprise three webs which receive the discs by the holes in the disc sliding over the webs so that the discs can be stacked on the support, the tripod being suspended from the baffle and held to the baffle by a spring assembly.

Thus, liquid flows through the grooves in the discs into the spaces defined by the webs and up through those spaces into the first chamber above the baffle.

Preferably the backwash system comprises a compressed air inlet for supplying compressed air to the second chamber so the compressed air forces the liquid through the first chamber and the grooves in the opposite direction to movement of the liquid being filtered to thereby push out any contaminants which are trapped in the grooves.

Preferably the first chamber has an air vent for venting air from the vessel after backwash.

The system may comprise a plurality of vessels, each including the said discs and the backwash system.

Actuators may be provided for controlling valves to, in turn, control the supply of compressed air, the air vent, the outlet of filtered liquid, the inlet of unfiltered liquid, and the contamination outlet for discharge of contaminants from the system.

Preferably the system includes a pressure differential measuring means for measuring the pressure differential between the inlet and the outlet, and for actuating the backwash system when the pressure differential reaches a predetermined level.

Preferably the pressure differential measuring means comprises a differential pressure indicating switch located in a bypass line connecting the inlet to the outlet.

Preferably a controller is provided for controlling the actuators and for controlling the backwash system upon receipt of a signal from the switch indicating that the predetermined pressure differential level has been reached.

### BRIEF DESCRIPTION OF THE DRAWINGS

A preferred embodiment of the invention will be described, by way of example, with reference to the accompanying drawings in which:

FIG. 1 is a view of the system of the preferred embodiment;

FIG. 2 is a detailed view of part of FIG. 1;

FIG. 3 is a plan view of a disc used in the embodiment of FIG. 1;

FIG. 4 is a detailed view of the circled part of the disc labelled A in FIG. 3;

FIG. 5 is a view along the line B-B of FIG. 3;

FIG. 6 is view along the line A-A of FIG. 5;

FIG. 7 is a detailed view of a disc assembly according to the preferred embodiment of the invention; and

FIG. 8 is a view of a vessel in a filtration plant according to the preferred embodiment of the invention.

### DETAILED DESCRIPTION OF THE PREFERRED EMBODIMENTS

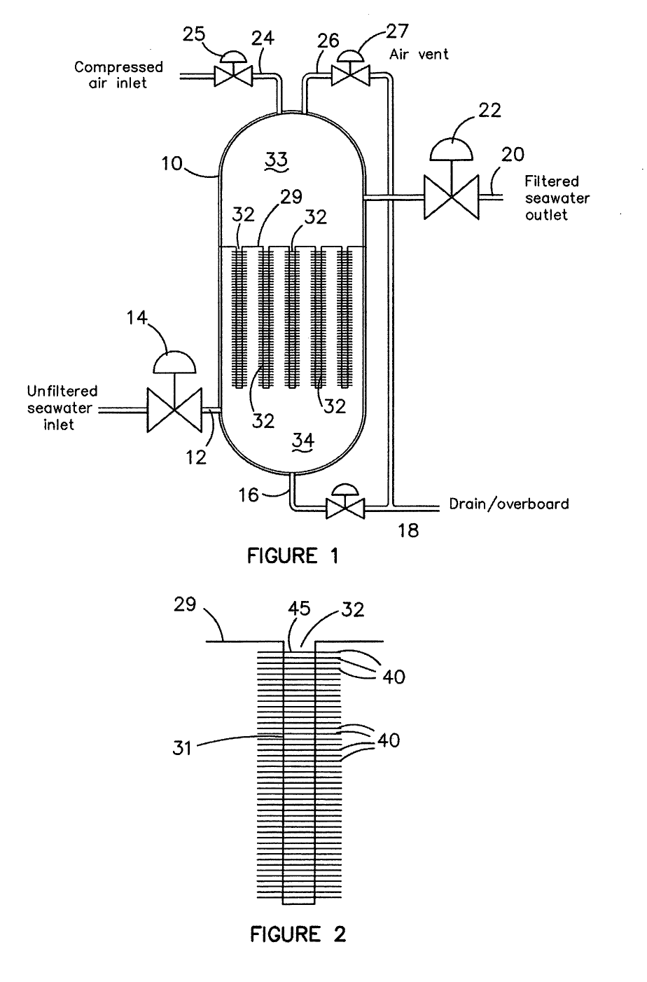

With reference to FIG. 1, a vessel 10 is provided which has an inlet 12 for unfiltered liquid (such as sea water in this embodiment of the invention). The inlet 12 is controlled by a control valve 14. The vessel 10 has an outlet 16 controlled via valve 18 for discharge of contaminant and an outlet 20 controlled via valve 22 for the discharge of filtered liquid (such as sea water). A compressed air inlet 24 and an air vent 26 are provided, each controlled by respective valves 25 and 27.

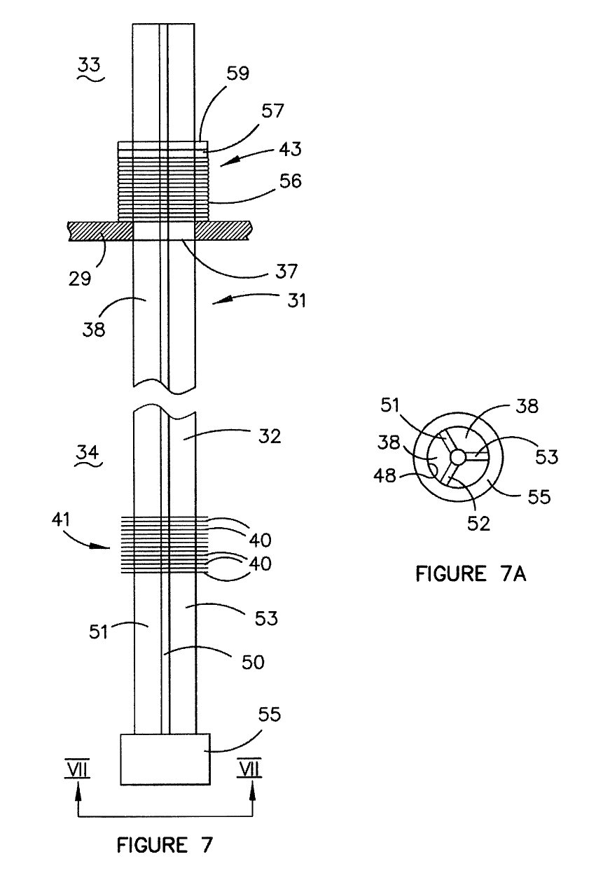

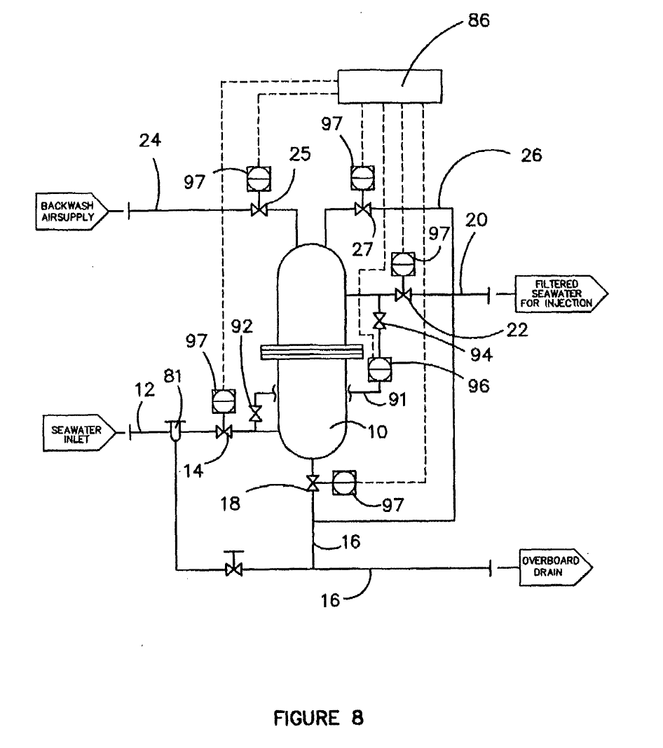

Arranged within the vessel 10 is a wall or baffle having a plurality of holes 29, each of which receive a candle 31. The candle 31 comprises a support web 32 and a plurality of discs 40 (which form a disc assembly 41) stacked on the web 32. The baffle 29 divides the vessel 10 into a first chamber 33 for filtered sea water and a second chamber 34 for unfiltered sea water. As is best shown in FIG. 7, the plurality of discs 40 are stacked one above the other on the support web 32 and the support web 32 is supported in place by a retainer spring assembly 43 which rests on the baffle 29 (see FIG. 7).

The discs 40 have a central hole 45 where they slip over the support web 32 and are defined by a first surface 46, a second opposite surface 47, an inner periphery 48 which defines the hole 45 and an outer periphery 49.

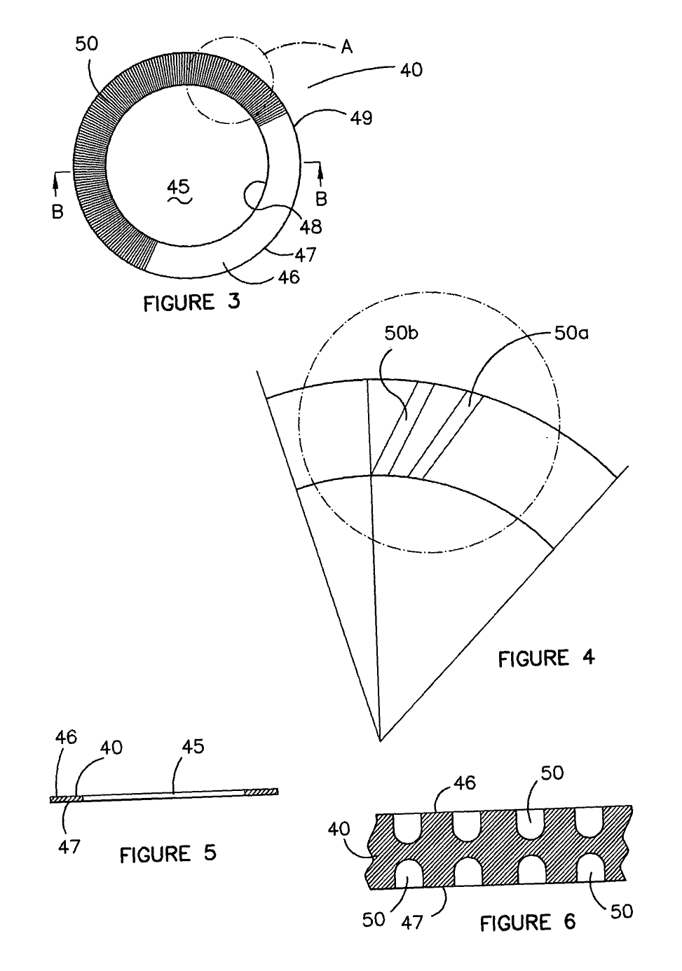

As is best shown in FIG. 3, a plurality of grooves extend from the inner periphery 48 in each of the surfaces 46 and 47 to the outer periphery 49.

FIG. 4 is a detailed view of part of the disc of FIG. 3 showing two grooves 50a and 50b. As is apparent from FIG. 4, the grooves are not perfectly radial, but rather are arranged at an angle of say about 30° to the radius of the disc 40.

The dimensions of the discs 40 may be as follows:
outer diameter defined by outer periphery 49: 35 to 40 mm
inner diameter defined by inner periphery 48: 24 to 28 mm
thickness of the disc between 0.5 to 0.75 mm
groove 50 having a normal rating size of about 5 to 2 micron
distance between centres of cavities 50 from 5 micron to 25 microns.

The discs 40 may be formed from any suitable material including polypropylene, polyvinylidene fluoride, polyvinyl chloride or polytetrafluoroethylene.

Again with reference to FIGS. 1 and 2, when it is desired to filter sea water, the valve 14 is controlled to allow the sea water to enter the chamber 34. The sea water is able to pass up beside the discs 40 and can travel through the grooves 50 of the discs to the support web 32, and then from the support web 32 into the chamber 33. The passing of the water through the grooves filters large colloidal material and other larger solids, thereby trapping that material so that filtered sea water can exit the outlet 20 when the valve 22 is opened.

Each of the discs therefore provides a predetermined flow rate and the effluent flow rate through the vessel 10 is determined by the number of discs and the number of stacks of discs which are employed.

When the amount of solids filtered by the discs has built up to a predetermined level, a backwash system comprised of the compressed air inlet 25 and air vent 27 is operated. Compressed air is supplied to the chamber 33 from the inlet 24 and passes in the opposite direction to the flow which performs the filtration so that any colloids or solids trapped in the grooves of the discs are blown out of the grooves or discs back into the chamber 34 where they can be discharged via the outlet 16.

The air vent 26 can be opened to vent any remaining air in the system out of the vessel 10 before the next use of the system.

The backwash operation can continue for a predetermined period of time before normal filtration occurs.

As is best shown in FIG. 7, each disc assembly 41 is supported on one of the support webs 32 which is formed from a central core 50 from which extends three web arms 51, 52 and 53. The central core 50 and arms 51, 52, 53 can be formed from angle iron with the arms 51, 52 and 53 disposed at an angle of 120° with respect to one another. The periphery of the arms 54 is matched to fit the inner periphery of the discs 40. Typically, the support web 32 may carry as many as 1000 filter discs 40. The bottom of the support web 32 is provided with a block or retainer 55 so the discs 40 cannot simply slide off the end of the support web 32.

The support web 32 passes through a hole 37 in baffle 29. The baffle 29 may be provided with as many holes as is desired and with as many candles 31 as is required to provide the required filtration flow. Typically a baffle can be provided with a predetermined number of holes 37 and if the holes are not provided with candles 31, the holes are simply blocked.

The space between the inner periphery 48 of the discs and the web arms 51, 52 and 53 form channels 38 which are generally wedge-shaped in cross-section so that liquid can flow up the channels 38 through the openings 29 and into the chamber 33 for exit through filtered sea water outlet 20.

Each of the support webs 32 is held in place by wave spring 56, a retaining washer 57 and a retaining ring 59. Thus, the liquid is able to flow through the spring 56, washer 57 and retaining ring 59 into the chamber 33 from the channels 34 between the inner periphery 48 of the discs 40 and the web arms 51, 52 and 53.

FIG. 8 is a schematic view of the vessel shown in FIG. 1 in more detail. Inlet sea water is provided via line 12 through strainer 81. The valve 14 controls inflow of liquid into the vessel 10 so that the liquid can flow through the various disc assemblies 41 previously described into chamber 33 and out through filter outlet 20. Inlet 12 and outlet 20 are connected to a control box 86 which monitors the flow and if a sufficiently large pressure differential is detected indicative of the fact that the discs 40 are becoming blocked with contaminants, the backwash system is operated. The backwash system includes the air supply line 24 which connects to the vessel 10 via valve 25 and vent 26 which connects to the vessel 10. The drain outlet 16 having the valve 18 is connected to the control box 86. When the pressure differential is determined, the valves 25 and 18 are opened and the valves 14 in the line 12 and 22 in line 20 are closed. Thus, air is pushed into the vessel 10 when valve 25 in line 24 opens, thereby forcing the liquid out in the reverse direction through the discs 40 and the drain 16. The operation of the backwash system can occur upon determination of a significant pressure differential, as detected by the control box 86, or may simply be timed to operate at predetermined time intervals. When the backwash has completed and air has blown through the discs 40, the valves 18 and 25 are closed. The valves 14 in line 12 and 27 in the vent line 26 are opened so that incoming water through the line 12 can push air trapped in the vessel out through the vent outlet 26. When all the air has escaped, the valve 27 is closed and the vessel 10 continues its normal operation by filtering water coming through line 12 and outletting the filtered water through line 20.

In embodiments where the backwash system is operated automatically when high pressure differential across the filter is reached indicating the filter being “clogged”. The inlet 12 connected to valve 92 and the outlet 20 connecting to valve 94 respectively provides the pressure impulses in line 91 to the differential pressure indicating switch 96. This switch 96 provides an indication of the difference in pressure between the inlet 12 and the outlet 20 and when this differential is at a predetermined high level, indicating that the filter is clogged, the backwash sequence is triggered by a signal to the controller 86.

The valves 14, 18, 22, 25 and 27 are operated by actuators 97 under the control of controller 86 to operate the filtration system and also the backwash system.

In preferred embodiments of the invention, a number of the vessels 10 may be connected together to form a filtration plant with the required inlet and outlet lines, drains and backwash systems so that a particular flow rate of filtered water is provided, as is required.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

Since modifications within the spirit and scope of the invention may readily be effected by persons skilled within the art, it is to be understood that this invention is not limited to the particular embodiment described by way of example hereinabove.

1. A liquid filtration system comprising:
a plurality of discs, each having a surface, an inner periphery and an outer periphery, a hole in each disc defining the inner periphery;
a support for supporting the discs one above another;
a plurality of grooves in the surface of each disc extending form the inner periphery to the outer periphery;
a vessel for containing the discs;
an inlet in the vessel for liquid to be treated so the liquid flows through the grooves in one direction, preventing or trapping contamination in the liquid from passing through the grooves in one direction;
a filtered liquid outlet for providing filtered liquid from the vessel;
a backwash system for providing washing gas for flow in the opposite direction to wash a drain off any retained contaminant out of the grooves; and
a vent system to remove trapped gas after backwash by allowing liquid to enter the vessel and push the gas out of the vessel through the vent system whilst the filtered liquid outlet remains closed.

2. The system of claim 1 wherein the surface of each disc is defined by a first surface and an opposite second surface, and a plurality of grooves are formed in both the first surface and the opposite second surface.

3. The system of claim 1 wherein the vessel is divided into a second chamber for receiving unfiltered liquid and a first chamber for receiving filtered liquid, the support means supporting the discs in the second chamber so that influent liquid must flow through the grooves of the disc for filtration before entering the first chamber.

4. The system of claim 1 wherein the support comprises a baffle having a plurality of downwardly extending support webs which are received in the holes of the discs so that liquid must flow through the grooves and then into the support webs a then into the first chamber, so that any contaminate is filtered by the discs during the passage of the fluid from the second chamber through the grooves to the first chamber.

5. The system of claim 3 wherein the first chamber has the liquid outlet for filtered liquid.

6. The system of claim 3 wherein the inlet for unfiltered liquid is located for communication with the second chamber.

7. The system of claim 4 wherein the support webs comprise three webs which receive the discs by the holes in the disc sliding over the webs so that the discs can be stacked on the support, the tripod being suspended from the baffle and held to the baffle by a spring assembly.

8. The system of claim 1 wherein the backwash system comprises a compressed gas inlet for supplying compressed gas to the first chamber so the compressed gas forces the liquid through the first chamber and the grooves in the opposite direction to movement of the liquid during filtering, to thereby push out any contaminants which are trapped in the grooves.

9. The system of claim 3 wherein the vent system comprises a controlled gas vent in the first chamber for venting gas from the vessel after backwash.

10. The system of claim 1 wherein the system comprises a plurality of vessels, each including the said discs, the backwash system, and vent system.

11. The system of claim 8 further comprising actuators for controlling valves to, in turn, control the supply of compressed air, the air vent, the outlet of filtered liquid, the inlet of unfiltered liquid, and a contamination outlet for discharge of contaminants from the system.

12. The system of claim 11 further comprising a pressure differential measuring means for measuring the pleasure differential between the inlet and the outlet, and for actuating the backwash system when the pressure differential reaches a predetermined level.

13. The system of claim 12 wherein the pressure differential measuring means comprises a differential pressure indicating switch between the inlet and the outlet.

14. The system of claim 12 wherein a controller is provided for controlling the actuators and for controlling the backwash system upon receipt of a signal from the switch indicating that the predetermined pressure differential level has been reached.

15. The system of claim 11 wherein the contamination outlet as in the second chamber and is open when the washing gas is supplied to the grooves.
